(19) United States
(12) Patent Application Publication
(10) Pub. No.: US 2026/0264684 A1
(43) Pub. Date: Sep. 10, 2026

(54) METHOD AND DEVICE FOR CONTROLLING A DECELERATION PROCESS OF A VEHICLE AND A CORRESPONDING COMPUTER PROGRAM INCLUDING A MACHINE-READABLE STORAGE MEDIUM COMPRISING THE COMPUTER PROGRAM

(71) Applicant: Robert Bosch GmbH, Stuttgart (DE)

(72) Inventors: Bo Hu, Marbach Am Neckar (DE); Hans-Peter Bechter, Oberstenfeld (DE); Michael Bachmann, Weissach (DE); Raphael Oliveira, Backnang (DE); Sebastian Opitz, Asperg (DE)

(21) Appl. No.: 19/165,760

(22) PCT Filed: Jul. 8, 2024
(86) PCT No.: PCT/EP2024/069190

§ 371 Date: Sep. 16, 2025

(30) Foreign Application Priority Data
Jul. 13, 2023 (DE) 10 2023 206 648.3

(51) Int. Cl. B60W 30/18; B60W 10/06; B60W 10/18

(52) U.S. Cl. CPC B60W 30/18109; B60W 10/06; B60W 10/18

(57) ABSTRACT

A method for controlling a deceleration process of a vehicle is described, wherein the vehicle comprises a brake system and a drive train. The method comprises the steps:
ascertaining a specifiable vehicle deceleration;
ascertaining an external force acting on the vehicle;
ascertaining an acceleration force of the vehicle to be generated by the drive train of the vehicle and a deceleration force of the vehicle to be generated by the brake system of the vehicle in order to decelerate the vehicle with the ascertained vehicle deceleration;
controlling the brake system and the drive train such that the ascertained vehicle deceleration is achieved as a function of the acceleration force and the deceleration force.

A corresponding device for controlling a deceleration process of a vehicle, a corresponding computer program and a corresponding machine-readable storage medium comprising the computer program are described as well.

### FIELD

The present invention relates to a method for controlling a deceleration process of a vehicle.

### BACKGROUND INFORMATION

In vehicles with automated or autonomous driving functions (SAE levels 1 to 5), control algorithms are used to control the acceleration of the vehicle and set it to a desired value.

Modern driving functions can also decelerate the vehicle to a standstill with a desired acceleration. In addition to maintaining a desired acceleration, there is also a requirement to not allow the vehicle to roll back when stopping on a slope.

When stopping while driving uphill, however, it is not possible to prevent the vehicle from rolling back and also exactly maintain the desired acceleration in all situations without simultaneously controlling the drive train and brake system.

An example of this is shown in the following:

In the example, a vehicle is to decelerate to a standstill on a slope with a gradient of 20% with a deceleration of −2 m/s\hat{ }2. The slope or its inclination would already decelerate the vehicle to a standstill at −2 m/s\hat{ }2. In this example, therefore, as long as the vehicle is still rolling, neither the engine nor the brake need to be actuated to set the desired acceleration.

However, as soon as the vehicle comes to a standstill, neither engine power nor braking force is available. This can indeed now be requested while at a standstill, but the vehicle will already roll back down the slope a little before the drive train and/or the brake system implements this request.

A force has to therefore be requested before the vehicle comes to a standstill to ensure that the vehicle does not roll back when at a standstill. This force must correspond to the downhill force. However, if the necessary force were now requested with the engine, the downhill force would already be compensated while driving. The total acceleration would therefore be 0 m/s\hat{ }2 and the desired acceleration would not be maintained, and it would also no longer be possible to decelerate to a standstill.

If a force corresponding to the uphill force (and thus a deceleration of −2 m/s\hat{ }2) were requested with the help of the brake system before coming to a standstill, the vehicle would decelerate to a standstill with a total of −4 m/s\hat{ }2. The braking force would then be sufficient at a standstill to prevent rolling back, but the desired deceleration of −2 m/s\hat{ }2 would not be maintained while stopping. Instead, the vehicle has undesirably reached a standstill with a deceleration of −4 m/s\hat{ }2.

It is therefore necessary to control both the engine and the brake system to prevent rolling back. Both forces would prevent rolling back at a standstill but, when rolling, the two forces would balance each other out so that the vehicle maintains the desired acceleration.

### SUMMARY

The present invention provides a method for controlling a deceleration process of a vehicle. The vehicle comprises a brake system and a drive train.

According to an example embodiment of the present invention, a specifiable vehicle deceleration and an external force acting on the vehicle are ascertained.

An acceleration force of the vehicle to be generated by the drive train of the vehicle and a deceleration force of the vehicle to be generated by the brake system of the vehicle are also ascertained in order to decelerate the vehicle with the ascertained vehicle deceleration.

The brake system and the drive train are then controlled such that the ascertained vehicle deceleration is achieved as a function of the acceleration force and the deceleration force.

This is advantageous because ascertaining the deceleration force takes into account that the drive train is actively being controlled to generate the acceleration force. This prevents excessive acceleration. If the active drive control were not being taken into account, the control algorithm would only significantly increase the braking force once the acceleration has already increased. This behavior can be avoided with this invention.

Further advantageous embodiments of the present invention are disclosed herein.

The method can be implemented by computer, for example.

The sum of the amount of the acceleration force and the amount of the deceleration force expediently corresponds at least to the amount of the external force acting on the vehicle. This is advantageous because it minimizes the bracing of the drive train with the brake system. If too much force were demanded of the drive train, drive train energy would unnecessarily be wasted and the wear on the brake system would be unnecessarily heavy. If too little force were demanded of the drive, it would not be possible to guarantee that rolling back could be prevented. Reducing the demand on the drive and the brake system, also reduces the noise produced by the drive and the brake system.

According to an example embodiment of the present invention, the deceleration force to be generated by the brake system is expediently ascertained such that it is at least half the external force acting on the vehicle. This is advantageous because it reduces the demands on the drive train and the brake system to the necessary minimum and reduces fuel consumption and brake wear.

According to an example embodiment of the present invention, the brake system and the drive train are expediently controlled before the vehicle comes to a standstill. This is advantageous because the acceleration force and the deceleration force both prevent the vehicle from rolling back when it is at a standstill, but balance each other out when the vehicle is rolling, so that the vehicle maintains the specified deceleration.

According to an example embodiment of the present invention, the deceleration process of the vehicle is expediently controlled until it comes to a standstill. This is advantageous because it ensures that the vehicle is braked at the specified deceleration throughout the entire stopping process.

According to an example embodiment of the present invention, the drive train of the vehicle is expediently actuated before the brake system. This is advantageous because the drive train usually reacts much more slowly than the brake system. This characteristic can thus be compensated.

The present invention also relates to a device for controlling a deceleration process of a vehicle, wherein the vehicle comprises a brake system and a drive train. According to an example embodiment of the present invention, the device comprises a means (i.e., an arrangement) which is configured to carry out the steps of a method according to the present invention. This makes it possible to achieve the aforementioned advantages.

The present invention also relates to a computer program comprising instructions that, when the program is executed by a computer, prompt said computer to carry out the steps of a method according to the present invention. This makes it possible to achieve the aforementioned advantages.

Another subject matter of the present invention is a machine-readable storage medium on which a computer program according to the present invention is stored. This makes it possible to achieve the aforementioned advantages.

### BRIEF DESCRIPTION OF THE DRAWINGS

Advantageous example embodiments of the present invention are shown in the figures and explained in more detail in the following description.

FIG. 1 shows a flow chart of a method according to the present invention according to an example embodiment.

FIG. 2 shows a schematic illustration of a vehicle that carries out the method according to the present invention.

FIG. 3 shows a schematic illustration of a device according to the present invention according to one embodiment.

### DETAILED DESCRIPTION OF EXAMPLE EMBODIMENTS

In all figures, identical reference signs denote identical device components or identical method steps.

FIG. 1 shows a flow chart of a method according to the present invention for controlling a deceleration process of a vehicle. The vehicle comprises a brake system and a drive train.

In a first step S11, a specifiable vehicle deceleration is ascertained. This can be an accordingly stored standard deceleration desired by a user in order to achieve a desired driving comfort, for example, or it can be ascertained from the vehicle longitudinal control as a value that has proven to be suitable in practice. The vehicle deceleration can also be ascertained by maintaining a constant distance to a preceding vehicle and thus adopting its deceleration, for instance.

In a second step S12, an external force acting on the vehicle is ascertained. This external force can include the downhill force, for example, and can be ascertained using a corresponding MEMS sensor, for instance.

In a third step S13, an acceleration force of the vehicle to be generated by the drive train of the vehicle and a deceleration force of the vehicle to be generated by the brake system of the vehicle are ascertained in order to decelerate the vehicle with the ascertained vehicle deceleration. The drive train is thus braced with the brake system. The sum of the amount of the acceleration force and the amount of the deceleration force can correspond at least to the amount of the external forces acting on the vehicle, for example. The deceleration force to be generated by the brake system of the vehicle can, for instance, be ascertained such that it is at least half the external force acting on the vehicle. After that, the acceleration force, for example, cannot be increased any further. The acceleration force can even be reduced again if the deceleration force becomes greater than half the downhill force, as long as the sum of the acceleration force and the deceleration force continues to correspond to at least the downhill force in terms of magnitude.

In a fourth step S14, the brake system and the drive train are controlled such that the ascertained vehicle deceleration is achieved as a function of the acceleration force and the deceleration force.

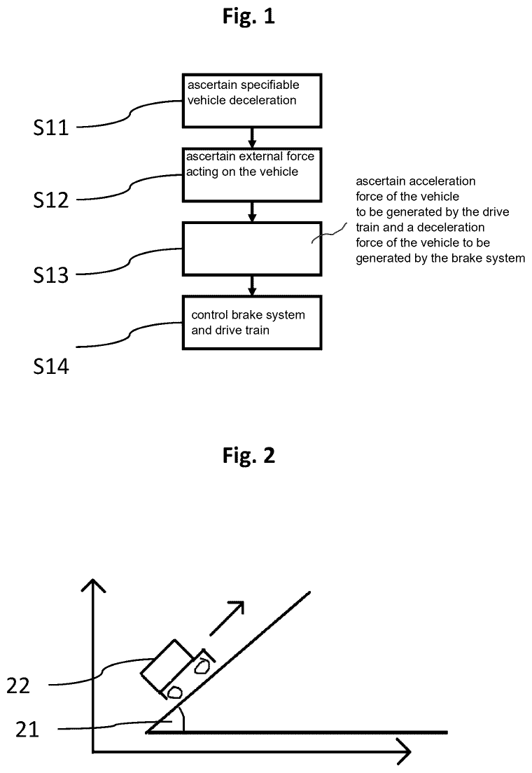

FIG. 2 shows a schematic illustration of a vehicle 22 that carries out the method according to the present invention. It can be seen that the vehicle 22 is driving up a slope with a specific angle 21. Because the weight force acts on the vehicle 22, a downhill force acts on the vehicle as an external force. A gradient of 20%, for example, corresponds to a deceleration of approx. 2 m/s\hat{ }2 caused by gravity acting on the vehicle 22. In this example, therefore, as long as the vehicle 22 is still rolling, neither the brake system nor the drive train or the engine need to be actuated to set the desired acceleration or deceleration.

As soon as the vehicle 22 comes to a standstill, however, there is neither an acceleration force from the drive train nor a deceleration force from the brake system. This can indeed now be requested while at a standstill, but the vehicle 22 would already roll back down the slope a little before the drive train and/or the brake system implements this request.

A force has to therefore be requested before the vehicle 22 comes to a standstill to ensure that the vehicle does not roll back when at a standstill. This force must correspond to the downhill force. However, if the necessary force were now requested with the drive train, the downhill force would already be compensated while driving. The total acceleration would therefore be 0 m/s\hat{ }2 and the desired acceleration would not be maintained, and it would also no longer be possible to decelerate to a standstill.

If a force corresponding to the uphill force, and thus a deceleration of 2 m/s\hat{ }2, were requested with the help of the brake system before coming to a standstill, the vehicle 22 would decelerate to a standstill with a total of 4 m/s\hat{ }2. The deceleration force would then be sufficient at a standstill to prevent rolling back, but the desired deceleration of 2 m/s\hat{ }2 would not be maintained while stopping. Instead, the vehicle 22 has undesirably reached a standstill with a deceleration of 4 m/s\hat{ }2.

It is therefore necessary to control both the drive system and the brake system to prevent rolling back. Both forces would prevent rolling back at a standstill but, when rolling, the two forces would balance each other out so that the vehicle 22 maintains the desired acceleration.

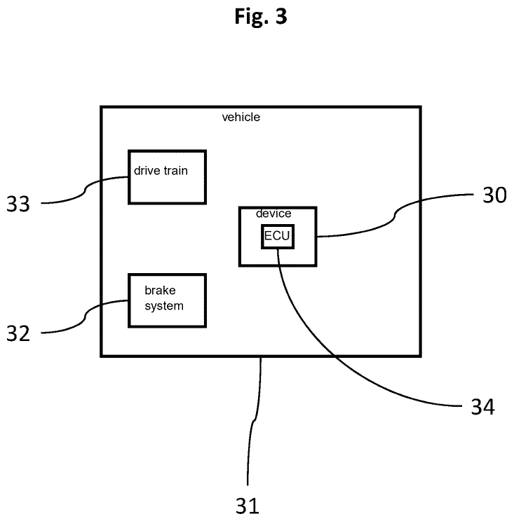

FIG. 3 shows a schematic illustration of a device 30 according to the present invention according to one embodiment. The device 30 according to the present invention is installed in a vehicle 31, which further comprises a brake system 32 and a drive train 33. The device 30 comprises a means 34 which is configured to carry out a method according to the present invention. The means 34 can in particular be an electronic control unit.

1.-9. (canceled)

10. A method for controlling a deceleration process of a vehicle, wherein the vehicle includes a brake system and a drive train, and the method comprises the following steps:
ascertaining a specifiable vehicle deceleration;
ascertaining an external force acting on the vehicle;
ascertaining an acceleration force of the vehicle to be generated by the drive train of the vehicle and a deceleration force of the vehicle to be generated by the brake system of the vehicle to decelerate the vehicle with the ascertained vehicle deceleration;
controlling the brake system and the drive train such that the ascertained vehicle deceleration is achieved as a function of the acceleration force and the deceleration force.

11. The method according to claim 10, wherein a sum of an amount of the acceleration force and an amount of the deceleration force corresponds at least to an amount of the external force acting on the vehicle.

12. The method according to claim 10, wherein the deceleration force to be generated by the brake system of the vehicle is ascertained such that the deceleration force is at least half the external force acting on the vehicle.

13. The method according to claim 10, wherein the control of the brake system and the drive train takes place before the vehicle comes to a standstill.

14. The method according to claim 10, wherein the control of the deceleration process of the vehicle takes place until the vehicle comes to a standstill.

15. The method according to claim 10, wherein the drive train is actuated before the brake system.

16. A device for controlling a deceleration process of a vehicle, wherein the vehicle includes a brake system and a drive train, and device comprises:
an electronic control unit configured to:
ascertain a specifiable vehicle deceleration,
ascertain an external force acting on the vehicle,
ascertain an acceleration force of the vehicle to be generated by the drive train of the vehicle and a deceleration force of the vehicle to be generated by the brake system of the vehicle to decelerate the vehicle with the ascertained vehicle deceleration, and
control the brake system and the drive train such that the ascertained vehicle deceleration is achieved as a function of the acceleration force and the deceleration force.

17. A non-transitory machine-readable storage medium on which is stored a computer program including instructions for controlling a deceleration process of a vehicle, wherein the vehicle includes a brake system and a drive train, and wherein the instructions, when executed by a computer, causing the computer to perform the following steps:
ascertaining a specifiable vehicle deceleration;
ascertaining an external force acting on the vehicle;
ascertaining an acceleration force of the vehicle to be generated by the drive train of the vehicle and a deceleration force of the vehicle to be generated by the brake system of the vehicle to decelerate the vehicle with the ascertained vehicle deceleration;
controlling the brake system and the drive train such that the ascertained vehicle deceleration is achieved as a function of the acceleration force and the deceleration force.
